(19) United States
(12) Patent Application Publication
(10) Pub. No.: US 2017/0308285 A1
(43) Pub. Date: Oct. 26, 2017

(54) SMART TERMINAL IRREGULAR SCREENSHOT METHOD AND DEVICE

(71) Applicant: ZTE CORPORATION, Guangdong (CN)

(72) Inventors: Yan LIU, Guangdong (CN); Jingwen GUO, Guangdong (CN); Can CAO, Guangdong (CN)

(73) Assignee: ZTE CORPORATION, Guangdong (CN)

(21) Appl. No.: 15/517,372

(22) PCT Filed: Jul. 1, 2015
(86) PCT No.: PCT/CN2015/083091

§ 371 Date: Apr. 6, 2017

(30) Foreign Application Priority Data
Oct. 17, 2014 (CN) 201410550864.0

(51) Int. Cl. G06F 3/0488; G06F 3/0484

(52) U.S. Cl. CPC G06F 3/04883; G06F 3/04842

(57) ABSTRACT

Disclosed a method and a device for an intelligent terminal taking an irregular screenshot. The method includes: recording and displaying multiple operational traces performed by a user while taking a screenshot; and when determining that an operational trace currently completed by the user and an operational trace previously completed by the user have formed a full screenshot loop, carrying out a screenshot operation according to the screenshot loop.

### CROSS-REFERENCE TO RELATED APPLICATION

This application is the 371 application of PCT Application No. PCT/CN2015/083091, filed Jul. 1, 2015, which is based upon and claims priority to Chinese Patent Application No. 201410550864.0, filed Oct. 17, 2014, the entire contents of which are incorporated herein by reference.

### TECHNICAL FIELD

The present disclosure relates to the field of mobile communication and, in particular, to a method and a device for an intelligent terminal taking an irregular screenshot.

### BACKGROUND

Nowadays, with rapid development of science and technology, the use of intelligent terminals has become increasingly common, and users' expectations and requirements on intelligent terminals are getting higher and higher. At present, the terminals on the market have a variety of screenshot functions, such as taking an irregular screenshot. However, such a screenshot method has some limitations, in that only when a user draws one line to form a loop, a screenshot can be successfully taken. When the user is not careful enough to form a loop with one line, the screenshot application will return to the original interface where no screenshot has been taken. Therefore, it imposes a high requirement on user operation, and it is not convenient for the user to operate.

This section provides background information related to the present disclosure which is not necessarily prior art.

### SUMMARY

Embodiments of the present disclosure provide a method and a device for an intelligent terminal taking an irregular screenshot, to overcome the technical problem that irregular screenshot imposes a high operation requirement.

An embodiment of the present disclosure provides a method for an intelligent terminal taking an irregular screenshot, including: recording and displaying multiple operational traces performed by a user while taking a screenshot; and when determining that an operational trace currently completed by the user and an operational trace previously completed by the user have formed a full screenshot loop, carrying out a screenshot operation according to the screenshot loop.

Optionally, the above method further including: when determining that an operational trace currently completed by the user and an operational trace previously completed by the user do not form a full screenshot loop, prompting the user to perform a subsequent operation, and performing a corresponding operation according to user's selection.

Optionally, the subsequent operation includes: continuing to complete the screenshot, taking another screenshot, and quitting the screenshot.

An embodiment of the present disclosure also provides a device for an intelligent terminal taking an irregular screenshot, including: a record module configured to record multiple operational traces performed by a user while taking a screenshot; a display module configured to display the plurality of operational traces performed by the user while taking the screenshot; and a screenshot module configured to, when determining that an operational trace currently completed by the user and an operational trace previously completed by the user have formed a full screenshot loop, carry out a screenshot operation according to the screenshot loop.

Optionally, the screenshot module is further configured to: when determining that an operational trace currently completed by the user and an operational trace previously completed by the user do not form a full screenshot loop, prompt the user to perform a subsequent operation, and perform corresponding operation according to user's selection.

Optionally, the subsequent operation includes: continuing to complete the screenshot, taking another screenshot, and quitting the screenshot.

An embodiment of the present disclosure also provides a computer storage medium storing computer executable instructions for performing the above method.

The embodiments of the present disclosure have the following advantageous effects.

When the user does not form a loop by a first operation, the user can draw lines for multiple times to form a loop and complete the screenshot. It can solve the problem that in the related art, irregular screenshot imposes a high operation requirement. Thus, the user can conveniently and freely take an irregular screenshot, enhancing user experience.

This section provides a summary of various implementations or examples of the technology described in the disclosure, and is not a comprehensive disclosure of the full scope or all features of the disclosed technology.

### BRIEF DESCRIPTION OF THE DRAWINGS

FIG. 1 is a flowchart illustrating a method for an intelligent terminal taking an irregular screenshot according to an embodiment of the present disclosure;

FIG. 2 is a block diagram illustrating processing modules of a method for an intelligent terminal taking an irregular screenshot according to an embodiment of the present disclosure;

FIG. 3 is a detailed flowchart illustrating a method for an intelligent terminal taking an irregular screenshot according to an embodiment of the present disclosure;

FIG. 4 is a schematic diagram of a first example according to an embodiment of the present disclosure; and

FIG. 5 is a block diagram illustrating a device for an intelligent terminal taking an irregular screenshot according to an embodiment of the present disclosure.

### DETAILED DESCRIPTION

Exemplary embodiments of the present disclosure will be described in more detail below with reference to the accompanying drawings. Although the exemplary embodiments of the present disclosure are shown in the drawings, it should be understood that the present disclosure may be embodied in various forms and should not be limited to the embodiments set forth herein. Rather, these embodiments are provided to enable a more thorough understanding of the present disclosure and to convey a complete scope of the present disclosure to those skilled in the art.

In order to solve the problem of high operational requirements for irregular screenshots in the related art, the present disclosure provides a method and a device for an intelligent terminal taking an irregular screenshot. The present disclosure will be described in further detail with reference to the accompanying drawings and embodiments. It is to be understood that the specific embodiments described herein are merely illustrative of the present disclosure, rather than limitation of the present disclosure.

### Method Embodiment

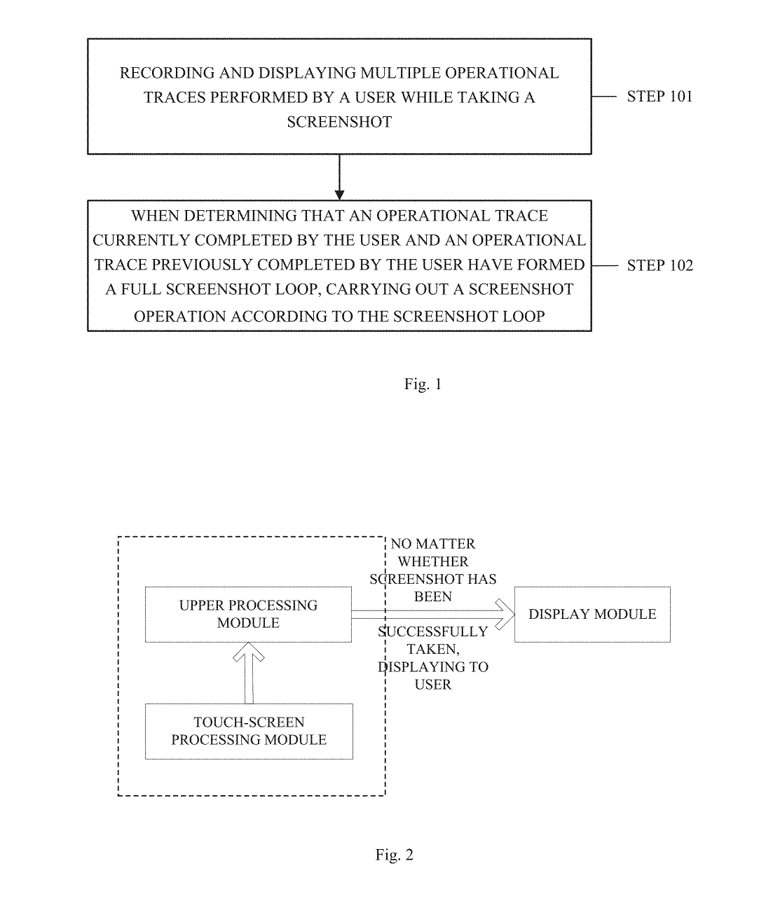

According to an embodiment of the present disclosure, there is provided a method for an intelligent terminal taking an irregular screenshot. FIG. 1 is a flowchart illustrating a method for an intelligent terminal taking an irregular screenshot according to an embodiment of the present disclosure. As shown in FIG. 1, the method for an intelligent terminal taking an irregular screenshot according to the embodiment of the present disclosure includes the following steps.

At step 101, multiple operational traces performed by a user while taking a screenshot are recorded and displayed.

At step 102, when it is determined that an operational trace currently completed by the user and an operational trace previously completed by the user have formed a full screenshot loop, a screenshot operation is carried out according to the screenshot loop. That is to say, when the current operational trace is a N^{th} operational trace, it is required to determine whether the current N^{th} operational trace performed by the user and a (N−1)^{th} operational trace performed by the user have formed a loop. If they have formed a loop, a screenshot is taken according to the loop and a new picture is generated. Thus, a screenshot is successfully taken. Wherein, N is an integer larger than or equal to 2.

Optionally, in the embodiment of the present disclosure, in the embodiment of the present disclosure, when it is determined that an operational trace currently completed by the user and an operational trace previously completed by the user do not form a full screenshot loop, it is possible to prompt the user to perform a subsequent operation, and to perform a corresponding operation according to user's selection. Here, the subsequent operation includes: continuing to complete the screenshot, taking another screenshot, and quitting the screenshot.

Hereinafter, the above described technical solution of the embodiments of the present disclosure will be described in detail with reference to the accompanying drawings.

FIG. 2 is a block diagram illustrating processing modules of a method for an intelligent terminal taking an irregular screenshot according to an embodiment of the present disclosure. As shown in FIG. 2, the method includes the following modules:

a touch-screen processing module, configured to record an operational trace performed by a user;

a display module, configured to display on a touch screen the operational trace on screen performed by the user, which is recorded by the touch-screen processing module; and

an upper processing module, configure to determine whether the operational trace currently completed by the user and the operational trace previously completed by the user have formed a loop, and if they have formed a loop, take a screenshot according to the loop and generate a new picture, then the screenshot is successfully taken.

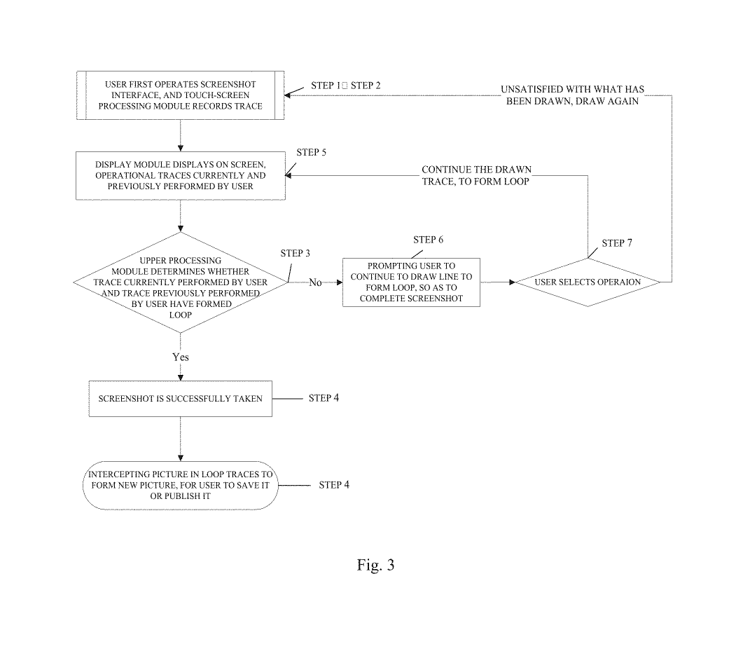

FIG. 3 is a detailed flowchart illustrating a method for an intelligent terminal taking an irregular screenshot according to an embodiment of the present disclosure. As shown in FIG. 3, the method includes the following steps.

At step 1, the touch-screen processing module records a trace performed by a user operating on the screen, and send data to the display module. If this is the first operation performed by the user, the process goes to step 2. If this is not the first operation performed by the user, the process goes to step 5.

At step 2, the display module displays on a touch screen the first operational trace on screen performed by the user, which is recorded by the touch-screen, and the process goes to step 3.

At step 3, the upper processing module determines whether the operational trace currently completed by the user and the operational trace previously completed by the user have formed a loop. If they have formed a loop, the process goes to step 4. If they do not form a loop, the process goes to step 6. If this is the first operation performed by the user, the upper processing module directly determines whether the operational trace currently completed by the user has formed a loop.

Step 4, the traces form a loop, a region is displayed according to the loop, and the screenshot is successfully taken. The current operation finishes.

Step 5, the display module displays, on the screen, the current operation screen trace performed by the user, which is recorded by the touch screen, and the process goes to step 3.

Step 6, the user is prompted to continue to draw a line to form a loop, so as to complete the screenshot, and the process goes to step 7.

Step 7, if it is determined that the user selects to continue the screenshot, the process goes to step 1; if the user selects to take another screenshot, the operation screen traces performed by the user, which have been recorded and displayed are cancelled. Then, the process goes to step 1.

### A First Example

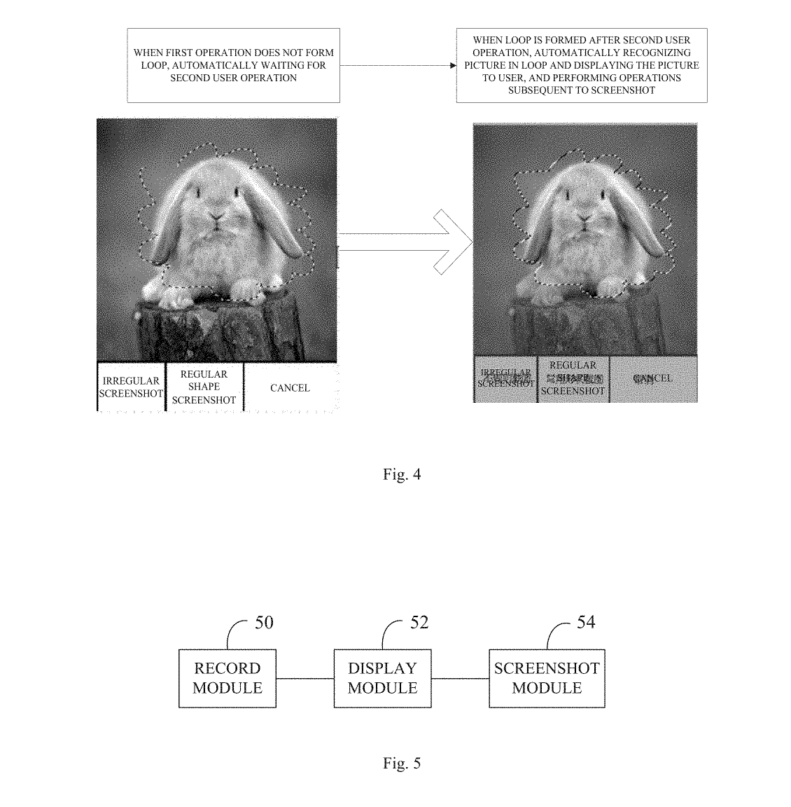

FIG. 4 is a schematic diagram of a first example according to an embodiment of the present disclosure. As shown in FIG. 4, the method includes the following steps.

At step 1, the user selects to take an irregular screenshot. The user arbitrarily draws a figure on the screen of the terminal. If the first operational trace forms a loop, the screenshot is successfully taken, and the process goes to step 4. If the first operational trace does not form a loop, the process goes to step 2.

At step 2, the user perform another trace operation, the interface display both of the second trace operation and the first trace operation simultaneously on the interface, and the process goes to step 3.

At step 3, it is determined whether the operational trace currently completed by the user and the operational trace previously completed by the user have formed a loop. If they have formed a loop, the process goes to step 4. If they do not form a loop, the interface displays three options to the user: “continue to complete the screenshot”, “take another screenshot”, “quit the screenshot” or other operations. The default selection is “continue to complete the screenshot”. If the user selects “take another screenshot”, the operation screen traces performed by the user, which have been recorded and displayed, are cancelled, and the process goes to step 1. If the user selects “quit the screenshot”, the screenshot interface is quitted.

Step 4, the screenshot is successfully taken.

Accordingly, with the technical solution of the embodiments of the present disclosure, when the user does not form a loop by a first operation on the screen, the user can continue to perform subsequent supplementary operations to complete the screenshot operation. Therefore, it is not required to form a loop by each single screenshot operation. Thus, when the user needs a complex regular figure or an irregular figure for a screenshot, the screenshot may be completed through multiple operations, improving the probability of successfully completing a screenshot, and eventually enhancing user experience in operating an intelligent terminal.

### Device Embodiment

According to an embodiment of the present disclosure, there is provided a device for an intelligent terminal taking an irregular screenshot. FIG. 5 is a block diagram illustrating a device for an intelligent terminal taking an irregular screenshot according to an embodiment of the present disclosure. As shown in FIG. 5, the device for an intelligent terminal taking an irregular screenshot according to the embodiment of the present disclosure includes a record module 50, a display module 52 and a screenshot module 54. Each of the modules of the embodiment of the present disclosure will be described in detail below.

The record module 50 (corresponding to the touch-screen processing module in the above described method embodiment) is configured to record multiple operational traces performed by a user while taking a screenshot.

The display module 52 (corresponding to the display module in the above described method embodiment) is configured to display the plurality of operational traces performed by the user while taking the screenshot.

The screenshot module 54 (corresponding to the upper processing module in the above described method embodiment) is configured to, when it is determined that an operational trace currently completed by the user and an operational trace previously completed by the user have formed a full screenshot loop, carry out a screenshot operation according to the screenshot loop. The screenshot module 54 is configured to:

when it is determined that an operational trace currently completed by the user and an operational trace previously completed by the user do not form a full screenshot loop, prompt the user to perform a subsequent operation, and perform a corresponding operation according to user's selection. Here, the above subsequent operation includes: continuing to complete the screenshot, taking another screenshot, and quitting the screenshot.

The process of each module according to the embodiment of the present disclosure can be understood with reference to the description of the method embodiment, which will not be repeated herein.

It will be apparent to those skilled in the art that various changes and modifications can be made to the present disclosure without departing from the spirit and scope of the present disclosure. Therefore, the present disclosure is intended to embrace such modifications and variations if the modifications and variations of the present disclosure are within the scope of the appended claims and the equivalents thereof.

The algorithms and displayed contents provided herein are not inherently relevant to any particular computer, virtual system, or other device. Various general-purpose systems can also be used with teaching herein. According to the above description, the structure required to construct such a system is obvious. In addition, the present disclosure is not directed to any particular programming language. It should be understood that the present disclosure may be embodied in various programming languages and that the foregoing description of a particular language is intended to disclose the best mode of the present disclosure.

A number of specific details are set forth in the specification provided herein. However, it will be appreciated that embodiments of the present disclosure may be practiced without these specific details. In some examples, well-known methods, structures, and techniques have not been shown in detail, so as not to obscure the understanding of this specification.

Similarly, it is to be understood that, in the above described exemplary embodiments of the present disclosure, the features of the present disclosure are sometimes grouped together into a single embodiment, figure or the description thereof, in order to simplify the present disclosure and to assist in understanding one or more of the various inventive aspects,. However, the disclosed method should not be construed as reflecting the intent that the claimed invention has more features than the features clearly set forth in each claim. More specifically, as reflected in the following claims, the inventive aspect has less than all the features of the previously disclosed in a single embodiment. Accordingly, the claims that follow the specific embodiments are expressly incorporated into this particular embodiment, and each claim is a separate embodiment of the present disclosure.

Those skilled in the art will appreciate that the modules in the client terminal in the embodiments may be adaptively changed and placed in one or more client terminals that are different from the embodiment. The modules in the embodiments may be combined into one module, and in addition they may be divided into a plurality of sub-modules or subunits or subcomponents. All of the features disclosed in this specification (including the accompanying claims, abstract and drawings) and any of the methods disclosed herein, or all of the processes or units on the client terminal, may be employed in any combination, except that such features and/or at least some of the processes or units are mutually exclusive. Unless otherwise expressly stated, each feature disclosed in this specification (including the accompanying claims, abstract and drawings) may be replaced with alternative features that provide the same, equivalent or similar purpose.

In addition, it will be understood by those skilled in the art that although some of the embodiments described herein include certain features included in other embodiments and not other features, combinations of features of different embodiments are meant to be within the scope of the present disclosure and to form different embodiments. For example, in any of the following claims, any one of the claimed embodiments may be used in any combination.

The various component embodiments of the present disclosure may be implemented in hardware, or implemented as software modules running on one or more processors, or in combination thereof. It will be appreciated by those skilled in the art that some or all of the functions of some or all of the components of a client terminal loaded with sorted URLs may be implemented using a microprocessor or a digital signal processor (DSP) in practice in accordance with an embodiment of the present disclosure. The present disclosure may also be implemented as a part or all of the devices or device programs (e.g., computer programs and computer program products) for performing the methods described herein. Such a program for implementing the present disclosure may be stored on a computer-readable medium or may have the form of one or more signals. Such signals may be downloaded from an internet web site, or on a carrier signal or in any other form.

It is to be noted that the above-described embodiments illustrate the present disclosure and are not to be construed as limiting the present disclosure, and that one skilled in the art may designate alternative embodiments without departing from the scope of the appended claims. In the claims, any reference signs between parentheses should not be construed as limiting the claims. The word “comprising” does not exclude the presence of elements or steps not listed in the claims. The word “a” or “an” before the element does not exclude the presence of a plurality of such elements. The present disclosure may be implemented by means of hardware including several different elements and by means of a suitably programmed computer. In the unit claims enumerating several devices, several of these devices may be embodied by the same hardware element. The use of the words “first”, “second”, and “third” does not indicate any order. These words can be interpreted as names.

### INDUSTRIAL APPLICABILITY

With the above described technical solutions, it is not required to form a loop by each single screenshot operation. Thus, when the user needs a complex regular figure or an irregular figure for a screenshot, the screenshot may be taken through multiple operations, improving the probability of successfully taking a screenshot, and eventually enhancing user experience in operating an intelligent terminal.

1. A method for an intelligent terminal taking an irregular screenshot, comprising:
recording and displaying multiple operational traces performed by a user while taking a screenshot; and
when determining that an operational trace currently completed by the user and an operational trace previously completed by the user have formed a full screenshot loop, carrying out a screenshot operation according to the screenshot loop.

2. The method according to claim 1, further comprising:
when determining that an operational trace currently completed by the user and an operational trace previously completed by the user do not form a full screenshot loop, prompting the user to perform a subsequent operation, and performing a corresponding operation according to user's selection.

3. The method according to claim 1, wherein the subsequent operation comprises: continuing to complete the screenshot, taking another screenshot, and quitting the screenshot.

4. A device for an intelligent terminal taking an irregular screenshot, comprising:
a processor; and
a memory for storing instructions executable by the processor;
wherein the processor is configured to:
record multiple operational traces performed by a user while taking a screenshot;
display the plurality of operational traces performed by the user while taking the screenshot; and
when determining that an operational trace currently completed by the user and an operational trace previously completed by the user have formed a full screenshot loop, carry out a screenshot operation according to the screenshot loop.

5. The device according to claim 4, wherein the processor is further configured to:
when determining that an operational trace currently completed by the user and an operational trace previously completed by the user do not form a full screenshot loop, prompt the user to perform a subsequent operation, and perform corresponding operation according to user's selection.

6. The device according to claim 5, wherein the subsequent operation comprises: continuing to complete the screenshot, taking another screenshot, and quitting the screenshot.

7. A computer storage medium storing computer executable instructions for performing the method according to claim 1.

8. A computer storage medium storing computer executable instructions for performing the method according to claim 2.

9. A computer storage medium storing computer executable instructions for performing the method according to claim 3.
